(19) United States
(12) Patent Application Publication
(10) Pub. No.: US 2014/0234826 A1
(43) Pub. Date: Aug. 21, 2014

(54) SYSTEM AND METHOD FOR EVALUATING AND TRAINING ACADEMIC SKILLS

(71) Applicant: CARMEL-HAIFA UNIVERSITY ECONOMIC CORP. LTD., Haifa (IL)

(72) Inventor: Zvia Breznitz, Haifa (IL)

(73) Assignee: CARMEL-HAIFA UNIVERSITY ECONOMIC CORP. LTD., Haifa (IL)

(21) Appl. No.: 14/198,978

(22) Filed: Mar. 6, 2014

Related U.S. Application Data
(63) Continuation-in-part of application No. PCT/IL2012/050350, filed on Sep. 6, 2012.
(60) Provisional application No. 61/531,704, filed on Sep. 7, 2011.

(51) Int. Cl. G09B 5/00

(52) U.S. Cl. CPC G09B 5/00
USPC 434/362

(57) ABSTRACT

System and method for improving reading speed and comprehension of a user that use a special software application operable through a computer processor. The method and system are configured for receiving personal details and reading level of the user; setting initial presentation pace and acceleration rate; presenting textual content over a computer screen, selected according to the received reading level and personal details; determining a current presentation pace according to the initial presentation pace and acceleration rate at each given timeframe; and manipulating presentation of text parts of the presented textual content at each given timeframe, according to the current presentation pace. The manipulation is done by erasing or blurring these text parts at a rate that corresponds to the current presentation pace.

### CROSS REFERENCE TO RELATED APPLICATIONS

This application is a continuation-in-part of international application no. PCT/IL2012/050350 filed on Sep. 6, 2012, which claims priority to Provisional patent application No. 61/531,704 filed on Sep. 7, 2011, both incorporated herein by reference in their entirety.

### FIELD OF THE INVENTION

The present invention generally relates to the field of computer implemented training programs and more particularly to computer implemented programs for evaluation and training of academic skills of users relating to various underlying cognitive abilities.

### BACKGROUND

Reading skills and other academic skills such as arithmetic skills, problem solving skills (e.g. solving of mathematical equations) and language related skills (e.g. acquisition and establishing of first and/or a second language) require combining a variety of underlying reading related skills such as phonological, orthographic and morphological skills as well as cognitive abilities such as attention, perception, short term, working and long term memory as well as speed of processing for fast and automatic processing of academic materials. Studies have shown that improved reading skills are indicative of a person's intelligence and cognitive abilities. Some studies show that slow reading pace (under a minimum threshold) can impair reading comprehension. This is caused due to limitations of the short attention span and short-term memory capacity, which cannot hold information for long periods of time. Numerous studies have shown substantial differences between individuals' exhibited performances and abilities and that performance levels are suboptimal. For example, in case of reading, each reader has his/her own individual routine reading pace. Although the reading pace varies for each individual, it may change according to factors such as fatigue, motivation levels and complexity of reading material. In many studies it was demonstrated that accelerating reading pace of readers of various ages and levels can increase the reading rate and improve decoding and comprehension skills of the readers. This phenomenon is known as the Acceleration Phenomenon (Breznitz, 2006). However, it was also indicated that this one-time manipulation is not sustainable and readers tend to revert to their routine suboptimal pace.

The term “reading skills” relates to various reading characteristics such as word decoding i.e. associating graphemes (letter signs) with phonemes (sounds), fast and automatic word retrieval from mental lexicon, reading fluency of words and paragraphs, both in silent and overt reading, reading comprehension including linguistic and semantic characteristics, or any other reading and/or linguistic skill known in the art. Some of these characteristics can be measured and defined according to different methodologies, research requirements, etc. For example, a reading pace may be defined as an average number of letters per a time unit or as the number of words per time unit. A reading fluency may be a reading characteristic that represents both the manner in which a person decodes the characters (decoding the letters to comprehend the word they represent and the oral manner in which the syllables and/or phonemes are pronounced), as well as the reading comprehension of an entire text part (e.g. a sentence or a part thereof that can be comprehended in terms of its meaning).

Many people suffer from reading impairments or other academic or learning disabilities associated with problems relating to one or more underlying language and cognitive skills. Developmental reading disabilities are not a unitary phenomenon and subtypes can be identified. For example, poor reading skills may be an outcome of neurobiological constrains, brain systems asynchrony, phonological, orthographic, speed of processing and or morphological deficiencies. Furthermore, poor readers can suffer from a variety of poor cognitive skills such as auditory and/or visual perception and or working memory. Reading disabilities may be caused by other causes such as acquired brain damages or other disorders such as Attention Deficit Disorder (ADD) or Attention Deficit Hyperactivity Disorder (ADHD)

Many people try to improve their reading skills even if they do not suffer any reading related impairment. One main effective method to do so is to read as much as possible reading materials that are as challenging as possible. Unfortunately, not all people have the time or the energy to invest in extensive reading. Many parents who wish their children would spend more time reading for improving their reading skills find it extremely difficult to convince them to do so.

Evaluating an academic skill such as a reading skill of users is a challenging task. Some researchers have tested cognitive and/or reading skills of users by monitoring brain activity using imaging and/or eye tracking technologies. These technologies are complimentary to behavioral studies and contribute a more in-depth and accurate evaluation and diagnosis of different patterns of reading skills at different ages and levels. However, they have minimal contribution to remediation of poor reading skills or improving academic skills of readers of any level.

### SUMMARY

According to some embodiments of the present invention, there is provided a system for evaluating and training academic skills of users. The system includes a user interface and at least one processing unit. The processing module comprises an evaluation module, which allows evaluating personal academic skills of each user by providing each user with an interactive evaluation program associated with the respective academic skill, using the user interface; and a training module, which uses evaluation of a specific academic skill of each respective user, provided by the evaluation module, for training the user by adapting a personal training program to the respective user according to the user's respective personal evaluation. The training module further allows operating and presenting each personal training program by using the user interface. The training comprises presenting content associated with said academic skill to the user and manipulating presentation characteristics of the content by manipulating a pace in which the content is presented starting from a pace that is associated with the evaluated personal academic skill of the user.

According to some embodiments of the present invention, the academic skills include at least one of: reading skills, problems solving skills, arithmetic skills.

Optionally, the evaluation includes presenting the user with text and determining a personal reading pace of the user and the training includes presenting text parts to the user and manipulating presentation pace of these text parts, according to the evaluated personal reading pace, thereby dictating reading pace of the user.

Additionally or alternatively, the system further enables monitoring performances of the user during training and adjusting the training according to the monitored performances substantially in real time during training, by manipulating presentation pace of the text according to the monitored performances of the respective user.

The system optionally further enables providing reports, each indicative of training performances of the user, according to the monitored performances of the respective user.

Optionally, the presentation pace manipulation includes erasing parts of the text according to reading order and according to a determined presentation pace.

Additionally or alternatively, the personal training program includes a number of training sessions each designed to be practiced at a different time period, each training session includes at least one reading exercise and at least one accuracy level exercise, wherein the training comprises determining an acceleration rate, indicative of an increase rate of the presentation pace of the text parts, where the acceleration rate is determined according to performances monitored during training, using the accuracy level exercises, wherein presentation pace is increased by the determined acceleration rate during each respective training session.

Each reading exercise is optionally followed by a reading comprehension exercise including at least one multiple choices question for enabling to measure accuracy level according to the number of correct answers to the questions.

Optionally, the evaluation module allows a pre-training evaluation and a post-training evaluation, wherein results of each of said pre-training and post-training evaluations are presented to the user.

According to some embodiments of the present invention, the system further comprising at least one monitoring database enabling to store training and evaluation related information of each training and/or evaluation of each user for monitoring performances of each user.

The evaluation and training modules are optionally operated through a web server for allowing using the system through at least one communication network.

Additionally or alternatively, the system further comprises at least one evaluation programs database including a multiplicity of evaluation programs and at least one training database including a multiplicity of training programs. The databases allow retrieval of evaluation and training programs according to input parameters and storage of programs and programs related data.

The user interface optionally allows the user to select a language out of a predefined list of languages, wherein the evaluation and training is carried out according to each respective selected language.

According to some embodiments of the present invention, the system further enables building, operating and presenting a personal training timetable indicative of schedules of sessions of the personal training program and alarm options, which allow outputting alarms indicative of each session according to the respective timetable. The system optionally automatically presents the personal timetable upon adapting the personal training program, where the UI enables the user to change schedule features thereof.

Additionally or alternatively, the training program includes at least one words game allowing a user to associate words with at least one category, where the training module enables calculating and assigning a time interval for presenting each word. The time interval is associated with the evaluated personal reading pace of the respective user and performances in previous training sessions.

The system according to claim 1 further comprising an administrator module enabling at least one administrator to receive text parts from at least one text source and construct at least one training and/or evaluation exercise out of each such received text part, wherein the user interface allows the administrator to carry out the construction of each training and/or evaluation exercise.

Optionally, the content presentation includes: visual content presentation, audio content presentation and/or tactile content presentation.

Optionally, the training module further enables providing warm up exercises each warm up exercise enables training at least one low-order cognitive skill, each such low-order cognitive skills is associated with the academic skill that is evaluated and trained.

According to some embodiments of the present invention, there is provided a computer implemented method of training and evaluating academic skills of users. the method comprises: evaluating at least one characteristic of at least one academic skill of a user by providing an evaluation program including an interactive evaluation platform associated with a respective academic skill; and training the user in the respective academic skill according to the evaluated personal academic skill characteristic. the training comprises presenting content to the user and manipulating presentation characteristics of the content by increasing a pace in which the content is presented starting from a pace that is associated with the evaluated personal academic skill characteristics of the user.

Optionally, the evaluation includes evaluation of reading pace and an accuracy level of the respective user in relation to a presented text, where the accuracy level is evaluated by presenting the user with a set of questions relating to a content of the text and calculating the respective accuracy level according to the number of correct answers in relation to the total number of questions.

According to some embodiments of the present invention, the evaluation comprises: receiving personal details of the user; retrieving an interactive evaluation program including at least one evaluation session, according to the personal details; presenting the user with content requiring the user to respond thereto; and evaluating at least one characteristic of the academic skills of the user according to the user responses to the presented content.

Optionally, the characteristics of the user's academic skill are also evaluated in respect to the personal details of the respective user.

According to some embodiments of the present invention, the at least one characteristic of the user's academic skill is further evaluated according to statistical information relating to the personal details and to the specific academic skill.

Optionally, the method further comprises monitoring a progress of each user during the training by storing performances characteristics in at least one predefined monitoring database.

Additionally or alternatively, the method further comprises adjusting the training according to monitored performances of the respective user, during said respective training.

Optionally, the monitoring further comprises ranking each performance of the user during the training, according to a predefined ranking mechanism and rewarding the user in respect to his ranking score.

Optionally, the method further comprises boost training including providing the user with booster training sessions to be trained by the user at a post training stage.

### BRIEF DESCRIPTION OF THE FIGURES

FIG. 1 is a block diagram, schematically illustrating a system for evaluating and training reading skills of users, according to some embodiments of the present invention;

FIG. 2 is a block diagram, schematically illustrating a system for evaluating and training reading skills of users, according to additional or alternative embodiments of the present invention;

FIG. 3 is a flowchart, schematically illustrating a process of evaluating reading pace of a reader and training the reader using an acceleration-based training program using the evaluation of the user's reading skills, according to some embodiments of the present invention;

FIG. 4 is a flowchart, schematically illustrating a process of an initial assessment of a user's reading skills, according to some embodiments of the present invention;

FIG. 5 is a flowchart, schematically illustrating a method of evaluating reading skills of the user using a refined assessment process based on results of the initial assessment process, according to some embodiments of the present invention;

FIG. 6 is a flowchart, schematically illustrating a process of training a user using an acceleration-based reading training program, according to some embodiments of the present invention;

FIG. 7A and FIG. 7B schematically illustrate a bobbles game that allows the user to associate words to categories, according to linguistic relations there between, according to one embodiment of a training exercise;

FIG. 8 schematically illustrates another airport association game, according to an additional or an alternative embodiment of a training exercise;

FIG. 9 schematically illustrates another television (TV) association game, having an indication of accumulated scores of the user, according to an additional or an alternative embodiment of a training exercise;

FIG. 10 schematically illustrates a flying balloon association game, having an indication of accumulated scores of the user, according to an additional or an alternative embodiment of a training exercise;

FIGS. 11A, 11B and 11C schematically illustrate a memory game, according to an additional or an alternative embodiment of a training exercise.

FIG. 12 shows a flowchart schematically illustrating a process for improving reading speed and comprehension, according to some embodiments of the invention.

FIG. 13 shows how the program can be implemented as a plug-in software application that can use other programs that present text, according to some embodiments of the invention, by adding-on a toolbar interface allowing the user/subject to operate the presentation manipulation according to various input data.

FIG. 14 shows a block diagram, schematically illustrating a system for improving reading speed and comprehension that includes an eye tracking device for automatically measuring eye movements for deducing reading speed of the user, according to some embodiments of the invention.

### DETAILED DESCRIPTION

Reading fluency can be presented in two ways as a dependent and as independent variable effects the level of reading skills. Reading fluency depends on factors such as reading pace and reading accuracy. Some studies have shown that when reading rate is being manipulated and the subject/user is being gradually forced, in a stair case procedure, to accelerate the reading rate beyond his\her routine (personal) rate, his/her reading fluency increases and the level of reading is enhanced. This phenomenon is called “the acceleration phenomenon”.

The Acceleration Phenomenon (Breznitz, 2006) indicates that when readers of various reading levels and ages are induced by external manipulations to read faster than their routine reading pace, improves comprehension and decoding. Conversely, when text is presented at a slower reading pace than the personal pace of each reader, readers' decoding accuracy improves, but their comprehension decreases significantly (Breznitz & Berman, 2003).

The acceleration phenomenon has been investigated in-depth and studies have shown that reading acceleration influences various cognitive processes that are activated in effective reading. Acceleration extends attention span, reduces distractibility (Breznitz et al., 1988, 1997a), helps overcome some of the capacity limitations of short-term memory, and enhances working memory processing (Breznitz & Share, 1992; Breznitz, 1997b). In addition, it increases word retrieval from the mental lexicon (Breznitz, 1997a) Results of these studies also indicate that by reading at a faster pace than routine reading rate the dyslexics made fewer hesitation errors and paused less between words in a sentence (Breznitz, 1997a, 1997b). Increasing reading rate appears to help dyslexic children partially surmount their phonological deficits (Breznitz, 1997a).

Based on the effectiveness of the acceleration phenomenon on the quality of reading, other research projects studied this phenomenon among various groups of impaired readers: young readers with attention deficits (Harpas & Breznitz, 1999), garden-variety poor readers (Norman & Breznitz, 1992; Breznitz & Norman, 1998), young developmental dyslexics (Breznitz, 1997a, 1997b), and acquired dyslexics (Birnboim et al., 2002). These studies also indicated that like regular readers, impaired readers could, with the acceleration manipulation, read faster than their self-paced routine reading rate (Breznitz, 1997a, 2008). During the acceleration of reading rate, all readers increased decoding effectiveness by reducing decoding errors. In addition, under the fast-paced condition, all readers except acquired dyslexics also increased their comprehension scores significantly. Results of studies conducted among adults in multiple languages with the acceleration manipulation indicated that adult college level regular readers could read about 10% faster (Breznitz et al., 1993; Breznitz & Leiken, 2000a) than their routine self-paced reading rate and their comprehension increased significantly. The adult dyslexics significantly reduced their decoding errors, increased comprehension and could read about 15% faster.

Studies involving brain-imaging technology have shown the effects of acceleration training on brain activity. ERP studies (Breznitz, DeMarco & Hakerem, 1993; Leiken & Breznitz, 1999; Breznitz & Leiken, 2000b) have suggested that among dyslexics the acceleration phenomenon enhanced the levels of incoming information at the perception level and during working memory processing. FMRI studies (Karni, Morocz, Bitan, Shaul, Kushnirb, & Breznitz, 2005) found that the brains of dyslexic and skilled readers showed different activation patterns in a self-paced reading condition, but in the fast-paced (accelerated) condition these differences were not found. The researchers proposed that decoding under the accelerated script may prompt the dyslexic brain to process graphemic information in a manner much closer to that employed by skilled readers. Based on the positive effect of the acceleration phenomenon on reading skill enhancement, a computer-based training program has been developed.

The present invention, in some embodiments thereof, provides computer implemented tools (systems and methods) that allow evaluating and training one or more academic skills of users such as reading skills, arithmetic skills, cognitive skills, problem solving skills and the like for enabling users to improve their personal performances by training according to their own personal abilities and progress.

The training is personally adapted to the user according to (a) the user's personal baseline performances (pre training), which are initially evaluated by the system, (b) the user's personal ongoing performances throughput the training; and (c) one or more personal details of the user such as age, personal preferences, language, cognitive/other impairment(s) and the like. The adaptation of the training to the user's personal abilities and level is, therefore, carried out according to the findings of a preceding evaluation process and optionally also according to the user's performances during the training process. In some embodiments of the present invention, in which reading skills are evaluated and trained, the system uses reading training programs that implement the acceleration phenomenon for improving users' reading skills.

According to some embodiments of the present invention, there is provided a system for evaluating and training academic skills of users such as reading and or writing and/or arithmetic and/or problem solving and or cognitive skills. The system allows evaluating characteristics of at least one academic skill of a user using an interactive evaluation program, adapting a personal training program for each respective user according to his personal evaluation; and training the user according the respective academic skill by using the adapted personal training program. According to some embodiments, the system adjusts to the training to the user according to his/her personal progress during the training by monitoring his/her performances in the training and adapting the next training exercise or session, accordingly.

The training may include presenting textual content (e.g. a sentence, a paragraph and the like) to the user over one or more types of presentation devices such as over a computer screen or mobile phone or tablet, and manipulating presentation characteristics of the presented content thereby dictating the reading pace. The manipulations may include any manipulation that can influence/dictate reading pace of the user such as visual and/or aural manipulations of the text and/or insertion of visual/aural effects that accompany the text presentation, which may influence/dictate reading pace. The visual manipulation of the text presentation may include, for instance, presenting text parts having a known content in a consecutive manner according to a predefined presentation pace in a manner in which part of text such as letters or words disappear (are erased) or fade out in some patterns, e.g. according to the reading order, from start of the text towards the end, and the pace that is determined according to the adaptation. The system may additionally enable monitoring performances of the user during the training, as mentioned above and change or adapt the training to the user's progress. This may be carried out by determining “an acceleration rate”, which determines the pace rate according to which the text is presented (e.g. determines a time interval for presenting each number of characters thereby determines a dictated reading pace for the user). The acceleration rate may be determined according to performances monitored during the training (e.g. using accuracy level tests such as reading comprehension, words associations and the like), where the presentation pace is increased by the determined acceleration rate during each respective training session and/or exercise. This allows considering not only the personal reading pace initially evaluated but continue evaluation during training for adjusting the training in a more accurate and suitable manner. The system may utilize several types of manipulation of content presentation along the training and/or evaluation sessions. For example, a training session may include reading parts in which text is visually presented and visually manipulated to control reading pace of the user while reading comprehension questions relating to each reading exercise may be presented aurally to the user (meaning that each question is voiced by a narrator, for example). To allow presenting content through various media types the system may be operatively associated or include various types of presentation devices such as a screen for visual presentation, speakers and/or earphones for audio presentation, and the like.

According to some embodiments, the system further enables tactile manipulation of the text presentation in embodiments in which the system is used for evaluation and training of users with poor eyesight or blind users. In these embodiments, the system may use a designated device for outputting the text in Braille, such as an electronic Braille typing machine, where the system can control typing pace and/or other tactile and/or aural text presentation effects.

The training may include variations of presentation pace of content throughout the training. For instance, in starting of training at an initial presentation rate, which is equivalent to the user's personal evaluated pace (e.g. evaluated personal initial reading pace), and gradually accelerating (e.g. increasing) the pace from one reading session or exercise to another throughout the training program by gradually increasing presentation pace. For instance, the presentation of a sentence may include presenting each word thereof at a certain rate, which may be translated into time intervals for presenting each word calculated according to an acceleration rate (depending on user's [performances and/or evaluation) and also according to the length of the word. Increasing the presentation rate may mean decreasing these time intervals for presenting each word.

According to some embodiments of the present invention, the evaluation of the level of the user in the specific skill field (e.g. reading skill) includes providing the user with an interactive platform of exercises that can measure his performances for obtaining a result of one or more characteristics (e.g. parameters) indicative of his level. The evaluation of the user's level may be carried out according to the user's performances in relation to his/her personal details such as age, language level, etc. and according to statistical information (e.g. norms) relating to these details.

The system may enable providing interactive evaluation programs, each associated with a different language, language level (a first language and second language and the like), area of interest, discipline, curriculum, users' age, disorders and the like. Each evaluation program may include a set of reading exercises that are designed according to the age, language level, personal preferences (e.g. fields of interests), discipline, curriculum, and/or disorder, of the user and the like. Each evaluation program may further be designed according to accumulated knowledge and statistics relating to evaluated reading or any other cognitive skills of users of various ages, languages, and of various disorders, etc. The system may include or have access to a multiplicity of evaluation programs each associated with a different age range, reading level (which may be associated with reading habits of elder readers), field of interest (content field), reading associated disorder/impairment, language, and the like.

The training program may include training sessions each including training exercises designed according to various ages, reading levels, field of interest, discipline, curriculum etc. Some characteristics of these exercises are adapted to the user's personal evaluation, creating thereby a personal training program tailored specifically to the user preferences according to his age, evaluated academic skills, area of interests, discipline, curriculum and the like.

For example, when referring to reading skills evaluation, the evaluation program may estimate the user's personal reading pace in relation to reading comprehension by presenting him/her with reading exercises each requiring the user to read text parts (e.g. a paragraph or a sentence) while enabling to measure the time it took the user to read each part, and presenting the user with a set of questions designed to assess the level of reading comprehension. This program may enable identifying a personal reading pace of the user by obtaining an index (e.g. mean value, median, best result, some percentile, etc) from measured reading time of each part. The index may be obtained only from exercises of which questions where correctly answered by the user or exercises scores that exceed a predefined threshold. This index may be defined in the system as a personal reading pace. For example, each evaluation session may include a number of exercises, each exercise including a reading exercise, in which a sentence is presented to the user requiring the user to press a key once finishing reading thereof, followed by a reading comprehension question requiring the user to select an answer out of presented ones. After a few such exercises, the evaluation of the personal reading pace of the user may include calculating the average of all reading pace measurements of each of the exercises in which the user had answered correctly to the associated question. Each such reading pace of each exercise may be calculated as the number of characters in the presented text (e.g. sentence) divided by the time measured between the beginning of the presentation of the text and the pressing of the key.

Once the user's personal reading pace has been evaluated, the system can tailor a reading training program that will present the user with text parts adapted to his/her age, language, reading level, personal preferences (e.g. areas of interest), etc. and control the presentation rate of parts of each presented text part for allowing manipulating and controlling the reading pace of the user. This may be done, for instance, by erasing letters or words thereby forcing the reader to read at an externally manipulated pace and preventing the reader from going back to erased parts when reading in a consecutive manner. This obviously depends on the order of the words in the text part and the dictated reading pace, which results from the manipulated presentation rate. The manipulation may allow starting at the personal reading pace of the user and increasing (accelerating) this pace gradually from sentence to sentence, exercise to exercise and/or session to session, for improving and increasing the user's personal reading pace, while maintaining or possibly improving reading comprehension and text decoding. Pace increasing (reading acceleration) can be obtained from session to session, exercise to exercise or event from one sentence to another within a single exercise. Each training exercise or training session may include an evaluation phase for monitoring progress of the user during training (The evaluation phase may appear repeatedly throughout the training session, at its termination and in order to assess the ongoing training effects, as well as post and long-post effects.

According to some embodiments of the present invention, the reading comprehension or any other type of accuracy testing exercise may be additionally or alternatively used for verifying reading of the associated text part and not necessarily for evaluating the actual accuracy level of the user.

This will allow implementing the findings of the acceleration phenomenon studies in a computerized tool such as software and/or hardware based evaluation and training programs that allow each user to practice on his/her own in privacy or in learning centers for allowing them to improve their academic abilities such as reading skills and the like according to their own personal initial evaluated level and according to the personal progress they make during the training. The content of the exercises such as the specific text parts and reading comprehension questions and/or the mathematical problems may be designed according to many studies made for testing reading and/or problem solving abilities in relation to users age, disorders, language and the like.

For example, the content of the text of each reading exercise may be determined according to several categories such age groups, reading impairment types, language levels (e.g. first language, second language etc.), content fields (revealing the subject to which the content of the text is related) and the like. The training and/or evaluation sessions including, for instance, the reading exercises and reading comprehension or any other accuracy testing exercises may be stored in one or more designated databases, each exercise and/or each session associated with one or more category according to a predefined data structure. The system may further allow an administrator (who is preferably skilled in the field such as a scholar in the field of education and the like) to update the database by selecting new reading materials and selecting and/or providing their associated accuracy testing exercises (e.g. reading comprehension question(s)) according to one or more of the categories. The system may include an administrator module that allow the administrator to input/select additional or alternative exercises, define their laws, rules, calculation techniques and the like and store them in databases.

For example, this administrator module may allow administrators to upload text parts from different sources (e.g. by allowing browsing and selecting online articles and the like), define the manner in which reading pace is calculated (e.g. by selecting “words per time unit” or “letters per time unit”), associate each text part to categories' values or definitions such as to a specific age group, content field, language level and the like. The association of each selected text part to the categories may automatically allow storing the text part in the database and registering its associated categories values/types in the database, according to its predefined data structure.

In the following description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The inventors of this invention currently test an additional application for adding a “booster training” for allowing users who already went through the training program to “boost” their academic skills level (e.g. reading level) by providing them with “booster training sessions”. The inventors, researching this subject, have found that long post effects of training may only sustain up to 3-6 months after the training, but tend to decrease relative to immediate post training effects. So the idea is to maintain optimal performance by periodontal boost training (e.g. once a week, once a month—still need to verify optimal time frame). Each boosting may include a very short (less than 5 minutes) training session, and may basically be a subset of the training session. The boosting is targeted at bringing the performances of the user back to his/her optimal level.

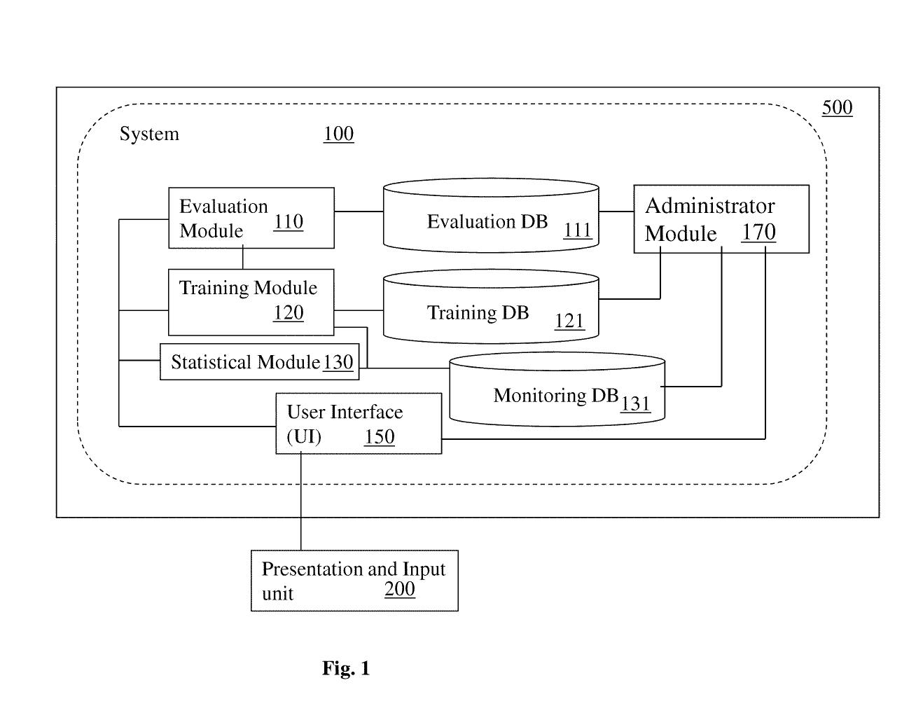

Reference is now made to FIG. 1, which schematically illustrates a system 100 for evaluating and training reading skills of users, according to some embodiments of the present invention. System 100 may include an evaluation module 110, a training module 120 and a user interface (UI) 150, operated by a main computer 500 connected to one or more presentation and input units such as a touch screen 200, and/or any other one or more presentation and input device that allows inputting data and outputting any type of media content such as text, voice, video and/or animation content and the like. Presentation and input unit 200 may include for instance, a touch screen, and/or a screen and keyboard, and/or a keypad and an audio system and the like.

According to some embodiments of the present invention, system 100 may additionally allow recording the user while orally reading at least one of the reading sections for practicing oral reading. For this purpose, system 100 may include and/or require an audio set including at least one audio receiver such as a microphone. The system may enable using one or more recording devices such as a microphone and programs (not shown) to allow recording the user.

Evaluation module 110 may enable accessing one or more evaluation databases such as evaluation database 111 for allowing retrieving evaluation programs and/or sessions and/or exercises thereof, while using UI 150 to present each evaluation exercise and allow the user to respond to the exercise and input other related data therethrough.

A number of evaluating programs associated with the same academic skill (e.g. reading or problem solving) may be available and stored at evaluation database 111 for allowing providing a suitable evaluation exercises to each user depending on personal details of the user such as his age, learning disabilities and the like.

For example, before each evaluation, the user may be required to input personal details such as his/her age, estimated reading level, first (native) language and optionally other languages and the like using UI 150 to allow the user to input this data through designated input fields. Once the mandatory input fields are inputted, evaluation module 110 selects exercises sets and/or an entire evaluation program that is associated in evaluation database 111 with at least some of the input details such as the user's age and estimated reading level. At least some of the reading exercises of the evaluation program may include a text portion such as a paragraph, which may be presented to the user through UI 150 allowing the user to input an indication that he/she has finished reading the text portion. Evaluation module 110 may then asses the reading pace of the user by, for example, dividing the number of characters in the presented paragraph by the time it took the user to read it.

The evaluation may include two evaluation sessions a first initial gross evaluation that measures that presents the user with a reading passage and requests the user to indicate when he finishes reading the passage by pressing a key, for instance. In the initial evaluation, a specified number of sentences (e.g., 18) are used to assess personal reading pace of the user. Each sentence appears in full on the computer screen and the user is instructed to begin reading it immediately. Once the user has read the entire sentence, he/she presses a designated key to signal that he/she has finished reading. The sentence then disappears from the screen and a comprehension question appears together with a number of possible answers. The trainee answers the question by pressing a designated key of the selected answer. Questions are based on information provided in the previous sentence. Once the comprehension question has been answered, another sentence appears on the computer screen followed by another question, and so forth. Reading times and comprehension scores are recorded for each sentence. The per-letter reading times across the sentences for which the user answers the comprehension question correctly are used to calculate the personal reading pace according to at least one predefined and optionally adjustable pace index (e.g. an average of all reading rates of all correctly answered sentences). This pace index becomes the basis for calculating the acceleration manipulation.

The second evaluation session may be a refinement of the previous evaluation and it may include presenting a set of sentences (e.g., 18 sentences). Each sentence appears in its entirety on the computer screen. The letters then begin disappearing from start to end of the passage, letter by letter, at a presentation rate calculated from the previous evaluation. If the user completes reading the sentence before all of the letters are erased, he/she may press a designated key (e.g. the space bar of the keyboard/keypad) to signal end of reading, and a comprehension question exercise appears showing a set of multiple choices questions. Reading time is calculated across sentences for which comprehension questions are answered correctly and a new reading pace is determined based on the gap between the two calculations. This new reading pace may be used as the final output personal reading pace to be used for the training of the user.

Additionally or alternatively, evaluation module 110 retrieves and presents one or more comprehension exercises, each comprising a set of questions relating to each presented text part, which may consist of a single word, list of words, a sentence, or multiple sentences, allowing estimating the level of reading comprehension of the user in relation to the user's reading pace and/or simply verifying that the user has read the text part. Each set of questions may be previously designed to fit a certain age, reading level, specific reading impairments, and the like. The questions may be multiple choices questions type meaning that each question is presented along with a number of optional answers, where at least one of them is the right answer and one or more of them are distracting answers. The user may be able to answer the presented questions by marking the answers using UI 150 options. The time it takes the user to answer may be either limited and/or measured by evaluation module 110. Once the questions set is answered by the user (and/or once the time limitation is through), evaluation module 110 checks the number of correct answers vs. the overall number of questions and optionally calculates the percentages ratio of correct answers thereby. This ratio may be defined as an “accuracy level”. The user may be required to repeat some such similar exercises including different text part and associated questions sets for determining a current personal reading pace of the user. The obtained reading pace may represent an ongoing reading pace of the user at current phase of the training. To determine the personal reading pace of the user, evaluation module 110 may average the reading pace of the text parts of which the user has acquired an accuracy level that exceeds a predefined threshold (if only one question is presented after each text part—only the text parts' time intervals that are associated with correctly answered questions may be considered for the personal reading pace evaluation).

Training module 120 may then receive the personal reading pace of the user from evaluation module 110 and/or from a database storing this information, achieved by using evaluation module 110, and adapt a personal training program for training the user in reading. The main objective of the training program is to improve or simply practice the reading of the user according to the user's “starting conditions”. The user's starting conditions may the evaluated personal reading pace and optionally also some of his/her personal details such as his/her age, learning/reading disabilities, languages and the like.

Once training module 120 receives this data (e.g. including the personal reading pace, age, accuracy level, etc.) it automatically adapts or builds a personal training program for the user, e.g. by identifying and retrieving exercises that are compatible with the user's personal reading pace and details. The training exercises may be retrieved from one or more training databases such as training database 121 or uploaded from one or more designated websites. Training module 120 may either combine these exercises into a program and associate each group of exercises to a different training session thereby constructing the training program for each received user input data. Alternatively, training database 121 may comprise entire training programs each associated with a different one or more reading pace, content field, age and the like, where training module 120 simply retrieves a program from training database 121 associated with the personal reading pace and/or other details of the user, which includes predefined training sessions. In the latter case, training database 121 includes a multiplicity of training programs each associated with one or more value or type of one or more category. For example a single training program may be associated with one age group, two content fields, and one language level.

Each such training program may include a number of training sessions; each training session includes a number of reading exercises. A recommended training routine may be offered to users that are trying to improve their reading skills, according to which each training session is to be exercises at a different time period preferably having at least one night sleep between each two consecutive sessions for allowing the user to properly assimilate the practiced cognitive skills.

In each reading part of the training exercises, each text portion (e.g. paragraph(s)) presentation may be manipulated according to the personal reading pace of the user as well as according to predefined “acceleration conditions” that are used for ultimately increasing the reading pace of the user from his/her personal pace upwards from session to session and/or from exercise to exercise. To allow this acceleration, training module 120 enables controlling and manipulating the reading pace by controlling and manipulating the presentation of the text in each reading exercise.

Presentation manipulation may include, for instance, manipulating the presentation rate of parts of the text according to reading order of the text by enabling to accelerate presentation pace thereof in relation to the evaluated personal reading pace of the user. This may be done by causing text parts (e.g. words, word parts or single letters) to fade out or by erasing them according (?) to a current reading pace, determined according to a progress level of the training at the current point of presentation (where the initial reading pace is the evaluated personal reading pace), and according to reading order of the text. Training module 120 depending on system 100 definitions and/or the exercise definitions and settings, may carry out other additional or alternative manipulations of graphical characteristics of the text. These additional/alternative graphical manipulations may include, for example, deleting text parts according to various rules and/or algorithms (e.g. syntactic, morphologic or semantic), highlighting text parts for indicating the user the parts of the text he/she should be currently reading and/or for assisting his/her reading comprehension, manipulating letters size, underling and/or bolding some of the words/letters according to reading order thereof, and the like.

According to some embodiments of the present invention, as illustrated in FIG. 1, system 100 additionally includes a statistical module 130 and at least one monitoring database 131. Statistical module 130 may enable storing or retrieving and analyzing statistical data including various parameters relating to performances of a multiplicity of users in relation to the one or more academic skills associated with the system.

For example, reading related characteristics of many users may be stored in monitoring database 131 or retrieved from any other data source. Each such characteristic of each user may be associated with the user's age, reading impairments, language, language level (e.g. first native language, second language, and the like), reading level, personal preferences (e.g. content fields) and the like. This information is used by statistical module 130 for calculating a different average general reading pace for each group of users for example for each group of users of the same age, reading level and to whom the language of interest is a firs/second language and so forth. These statistical calculations may be used for adjusting and improving both evaluation and training programs to the users according to their personal details (e.g. age, reading level, language level, etc.).

According to some embodiments of the present invention, monitoring database 131 is additionally or alternatively used for storing users' resulting scores of each evaluation and/or training exercise they perform for allowing adapting the training sessions/program and/or for allowing to add these results to the statistical information used by statistical module 130. Storing each performances parameter of each user may additionally allow indication of performances layout to each user to encourage the user to improve his/her performances.

For example, the monitoring and storing of parameters associated with user's performances along the training may be also used for a ranking and rewarding mechanism allowing to rank the user's current improvement and reward the user for successful performances. Training module 120 may save measured and/or calculated parameters such as reading pace, accuracy level and the like of each exercise or session along with the personal details of the user to allow the ranking and rewarding the user when at least one of these parameters exceed a threshold limit. This limit may be predefined and statistically calculated in relation to the user's age, language level and the like, or calculated according to the user own personal abilities and former scores. Each training program or part of program may be in a format of a game especially programs for children under a predefined age (e.g. for all users under the age of 15) allowing users to score points and play while improving their reading and/or problem solving skills, and the like.

According to some embodiments of the present invention, system 100 additionally includes an administrator module 170 for allowing administrators to update or change content and optionally structure of databases 111 and 121. For example, administrator module 170 may be associated with UI 150 to allow administrators (such as human experts in one or more fields relating to the academic skill) to upload text parts from different sources (e.g. by allowing browsing and selecting online articles or by receiving incoming articles and the like), define the manner in which reading pace is calculated (e.g. by selecting “words per time unit” or “letters per time unit”), associate each text part to categories' values or definitions such as to a specific age group, content field, language level and the like. The association of each selected text part to the categories may automatically allow storing the text part in the database and registering its associated categories values/types in the database, according to its predefined data structure. For this purpose, UI 150 may include an administrator interface for allowing selecting or changing categories, definitions and the like.

According to some embodiments, The system may enable a process in which content arrives (pooled/pushed) to a designated database and human experts then adapt/compile the content based on characteristics of the target population, related academic skills, etc. The expert may add related questions to the adapted content in order to test comprehension in relation to the content of each content piece (e.g. article, story and the like). As an example, the system includes a gateway (e.g. web feeder, RSS) to a content website (such as Wikipedia™). According to this example, the system provides an interface for an expert to adapt articles from Wikipedia™ to a format that is compatible with the program training, including reduction of complexity e.g. by using a reduced vocabulary and/or by rephrasing some of the sentences, reducing the number of segments/paragraphs/sentences, adding comprehension questions (and associated answers), etc.

Additionally or alternatively, administrator module 170 enables automatically searching and locating text parts to categories to update or create databases 111 and 121 according to predefined rules, criteria, and the like. For example, administrator module 170 enables carrying out linguistic, categorization and/or other types of analysis of articles of one or more websites (e.g. a news website) for determining the categories association and level of each article and for determining whether to select the article or part(s) thereof for the evaluation and/or training. To do so, administrator module 170 may identify the content field(s) associated with the article or part(s) thereof according to tags of the article and/or by identifying and analyzing meaning of most frequent words, etc.

According to some embodiments of the present invention, administration module 170 may enable receiving data including, for instance, age of the user, language level and/or content field of choice inputted by the user and search online (substantially in real time) for suitable text parts according to the input details for the evaluation and/or for the training process.

According to some embodiments of the present invention, one or more methods may be used for selecting or constructing evaluation and/or training exercises. Some of them may be based on language and/or semantic rules requiring the user to associate words, answer logics questions relating to context and/or content, detecting if a target word appears in a subsequent list of words and the like.

According to some embodiments of the preset invention, system 100 may additionally enable providing “cognitive training exercises” for allowing additional training of fundamental cognitive skills that are related to the academic skill that is evaluated and trained using system 100. For example, reading ability is an academic skill that is considered a higher-order” cognitive skill requiring the user (reader) to operate or user several “low-order” cognitive skills (or fundamental cognitive skills) such as perception, attention, memory of various types, etc. In some embodiments, training module 120 provides the user with “warm up” exercises; each one or more warm up exercise precedes a training session and/or training exercise. Each warm up exercise is designed to train one or more low-order cognitive skills that is/are associated with the higher-order academic skill that is to be trained. For example in reading training sessions each training session may begin with a set of warm up exercises for training (with the purpose of improving) these related low-order skills. For instance, each reading training session may begin with a set of warm up exercises including one or more memory exercises, attention exercises and the like.

For example, reading is known to rely heavily on serial attributes of perception, global/local features of visual material, working memory and other. In contrast, problem solving is less sensitive to perception attributes and more to working memory and high order functions like executive functions of the cognitive system (e.g. planning, error detection and control, etc.). The idea is that in order to achieve optimal performance before dealing with a specific academic exercise (i.e. reading material for an exam), it may be helpful to provide a short cognitive warm-up (e.g. less than 5 minutes) that is tailored to the specific underlying cognitive functionality of the requirements of the exercise, much like a warm-up before physical exercise. Training these related a low-order (specific) set of cognitive abilities enables enhancing the corresponding (related) higher-order academic skill that (at least in part) relies on this set of low-order cognitive abilities. The warm up may be used in training and/or in post training (e.g. before each booster session).

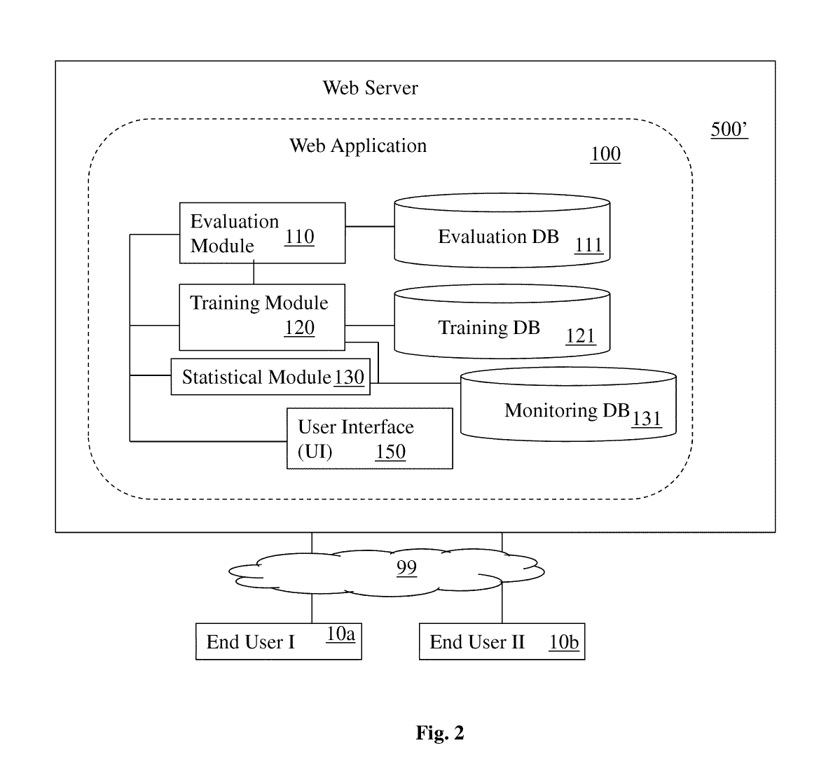

System 100 may be any type of software and/or hardware component operated by any type of computerized system 500. For example, as illustrated in FIG. 2, system 100 is a web application operated by a web server 500′ to enable a multiplicity of end users such as first and second end users 10a and 10b, respectively, to communicate therewith through at least one communication link such as through an internet communication link 99. This will allow users to open personal accounts through a designated website enabling to operate all UI 150 operations for presenting and receiving of data. The personal details of the user, inputted by him/her to open the account may be stored in monitoring database 131 along with information relating to previous sessions of each program the user is training, to allow web application 100 to upload the next session/exercise according to previous sessions/exercises and their performance characteristics. For example, if a user has started a training program including twelve sessions. And had already gone through five sessions, the next session will be uploaded while automatically uploading the user's personal details and former scores.

Web application 100 may additionally enable operating and presenting a schedule interface using UI 150. The schedule interface may allow reminding a user regarding future unpracticed sessions and/or exercises by using any one or more types of presentation tools. For example, once a training program is built or adapted for the user, a timetable may automatically be constructed and presented including indication of dates and hours when each training session should be practiced. The timetable may further include alarm options, which may allow outputting audio and/or visual alarms prior to each session. UI 150 may further allow the user to adjust the training schedule, where a default adjustable recommended timetable is presented allowing the user to change and/or set features such as sessions schedules, alarm setups and schedules and the like. UI 150, for example, may graphically present the time schedule by showing a graph of hours vs. days where each marked sign (such as a cross or a point) on the graph may represent the time and day of the session according to the sessions order. UI 150 may also allow graphically adjusting the sessions and/or alarm schedules by standing on the sign representing each session and moving it to set a new hour and/or day for each session.

According to some embodiments, when using the acceleration manipulation for dictating reading pace, the manner of erasing the text from start to end may take several forms. For example, when presenting a single word or a list of words, the text manipulation includes erasing an entire word at a time. In contrast, when presenting sentences or a paragraph, the manipulation may include erasing a letter at a time. However, these are only typical scenarios and various presentation manipulation methods may be used.

According to some embodiments of the present invention, other additional or alternative training exercises and techniques may be used such as word association, which requires users to associate words to categories (e.g. semantic categories), associating or marking rhyming words, judgment of logics of sentences and the like. The reading comprehension exercise may additionally or alternatively include a set of sentences relating to the text having blank spaces the user is required to fill and the like.

According to additional or alternative embodiments of the present invention, the reading pace evaluation may include presenting single words to the user having similar or identical length (number of characters) and requiring the user to either pronounce the word or indicate that he/she has finished reading the word, for evaluating only decoding pace. This may be useful for users of age and/or reading level in which they are starting to read (e.g. children under the age of five or older users with severe reading impairments).

According to some embodiments of the present invention, system 100 may additionally enable providing reports indicative of some of the user's personal details (e.g. name, age, grade, personal preferences, language(s) level(s) and the like) and the progress of the user during training, using one or more reports format. The report may be created upon request of the user and/or of an authorized user such as a guide of the user, an administrator and the like. For example, the report may include a graph or a table indicative of all calculated reading paces of the user during the evaluation and training, starting at the personal reading pace. Additionally or alternatively, system 100 enables an authorized user to change acceleration rate and optionally other parameters during the training. This is to allow the guide to intervene if he/she identifies that the training rate is not suitable for the user.

According to some embodiments of the present invention, system 100 allows the user to repeat exercises by providing a “repeat option” in UI 150 and optionally also allow the training user or any other authorized or non-authorized user such as a guide a teacher and the like to select and change presentation pace and/or the acceleration rate. For example, a virtual speed scale having a setup bar presented by UI 150 may allow the user to set the presentation pace and/or the acceleration rate by locating the bar along the scale and thereby determining the desired pace/rate.

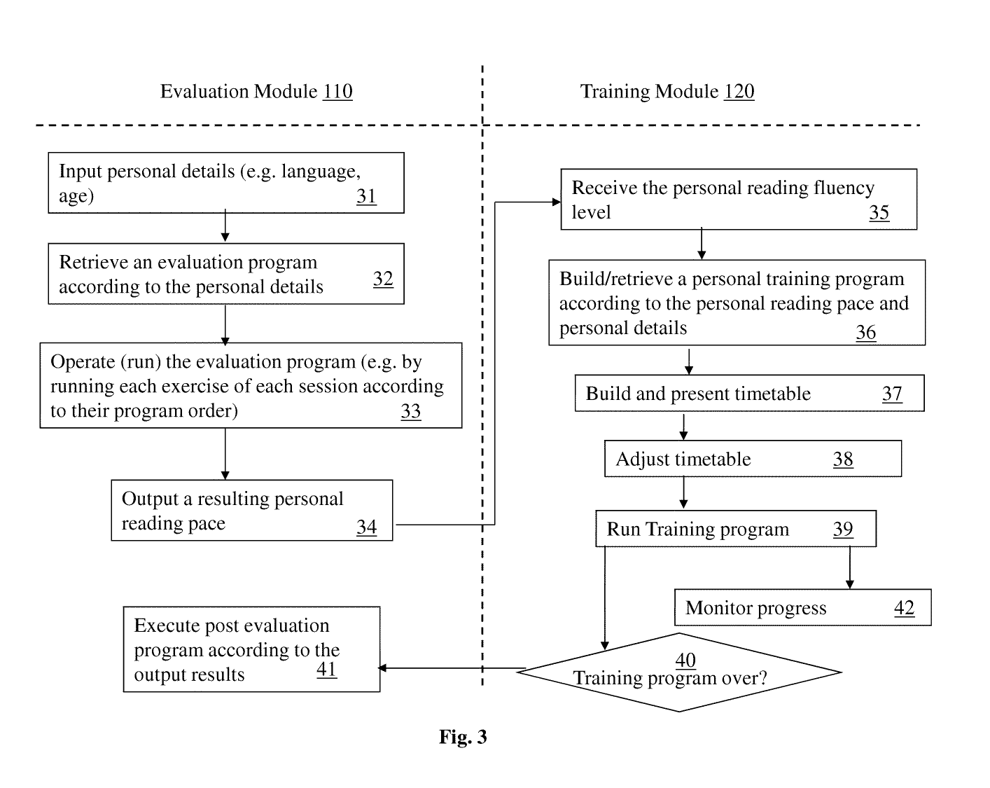

Reference is now made to FIG. 3, which is a flowchart, schematically illustrating a process of evaluating reading characteristics of a user and training the user, using an acceleration-based training program, according to the reading skills evaluation, according to some embodiments of the present invention. According to this process, the user inputs personal details 31 such as the user's age, languages and level of each language, estimated reading level, area of interest, any one or more known reading impairments etc. Once the details are inputted, evaluation module 110 retrieves an evaluation program that is associated with at least one of those input details 32. For example, each evaluation program in evaluation database 111 may be associated with a single age and a single language level. So that a user of age twelve to whom English is a first language will receive a different evaluation program in English than a user of the same age to whom English is a second language.

Once the evaluation program is retrieved it is operated 33 by evaluation module 110 using UI 150 and presentation and input unit 200 to present reading sections (e.g. paragraphs) and allowing the user to interact with the program by, for example, marking when he/she has finished reading the reading section (e.g. by pressing a virtual key in touch screen 200) an marking each answer the user think is correct in the reading comprehension exercises. Once all exercises of all sessions of the evaluation program are completed, evaluation module 110 outputs a resulting personal reading pace evaluation 34. The personal reading pace PRP may be calculated according to any predefined method such as those described above.

Training module 120 receives the evaluated personal reading pace and other required personal details of the user 35, such as the user's age, language level etc. Training module 120 then either builds or retrieves a training program including multiple training sessions each session including one or more pairs of training exercises 36 and may build and present a recommended timetable 38 for carrying out the training sessions. The user may adjust one or more features of the timetable 38 using a special GUI that allows him to change days and/or hours of each of the sessions.

Each of the training sessions may be operated by training module 120 by receiving some confirmation indication from the user such as by presenting the user with a confirmation window when the session is about to begin according to the timetable, where each session is then ran once receiving the session confirmation 39. As mentioned above, each training session may include pairs of exercises. Each pair includes a first reading exercise, in which a reading section is presented to the user according to a graphical presentation that is related to a presentation rate, which allows dictating the reading pace of the user to some extent. The text may be presented sentence by sentence where the words of each sentence gradually disappears to prevent the user from going back to the beginning of the sentence after a while. In this way training module 120 controls the reading pace of the user by manipulating the presentation of parts of the text according to the reading order (left to right and the like—depending on the language). Immediately after the reading exercise is over, training module 120 presents a reading comprehension exercise, or any other type an accuracy exercise relating to the content of the reading section. This reading comprehension exercise includes a set of multiple choices questions, which enables estimating the user's reading comprehension by measuring the accuracy level as explained above.

The dictated reading pace of each reading exercise may be determined according to the personal reading pace of the user as well as according to his progress along the session and/or the program. For example, in the very first exercise pair of the first training session of the training program, the presentation rate is proportional to the personal reading pace of the user, received from evaluation module 110. In the next pair of training exercises the presentation rate is increased (meaning that the time interval for presenting each text part is decreased) by an “x” rate (which may be calculated in real time or a predefined constant rate). This may apply only if the results of the reading comprehension exercise exceed a predefined accuracy level. For example, if the accuracy level is over 80%, meaning that more than 80% of the answers are correct, then the next presentation rate is increased by 2% in relation to the previous one or in the case of the second exercise 2% of the personal reading pace. This rule may be applied in every exercise pair taking the previous presentation rate and increasing it by the same predefined rate “x” if the user has succeeded exceeding a threshold accuracy level. Each exercise pair may be associated with the same accuracy level threshold or different ones, depending on system 100 definitions.

Once the last training session is over 40, the user may be advised and/or directed to a post-training evaluation 41 executed and operated by evaluation module 110. The post-training evaluation may be administrated any time after the completion of the training program. For instance, immediately after training or some months (e.g. 3 or 6) after training (long-post evaluation). The post-training evaluation program may be similar to the pre-training evaluation program in content and difficulty level to check if there has been any improvement in the reading skills of the user. Optionally, system 100 allows directing and/or advising the user to use another more advanced training program to continue practicing his/her reading.

Optionally, as illustrated in FIG. 3, the training process may be monitored 42 enabling storing all resulting parameters of each reading exercise such as every reading pace and accuracy level of the user to allow accumulating statistical data of each user and of all users of system 100. The monitoring may additionally or alternatively be used for adjusting the training to the user's progress during the training in real time, by adapting the presentation pace and acceleration rate to the user's current and/or accumulated performances.

In the embodiments described in relation to FIGS. 1-3, only reading academic skills are discussed. Notwithstanding, similar system configurations and method steps may be described in case the academic skill that is evaluated and trained is different. For example, in case of evaluating problem solving skills each evaluation and/or training exercise may include a mathematical exercise or any other problem type, while the pace of the user relates to the time it takes the user to solve the problem (e.g. solve the equation). The acceleration technique, in these cases may include manipulating presentation of mathematical exercises by causing parts of each equation to fade out or by limiting the presentation time of the equation to be solved in any other manner and then requesting the user to select a solution out of a predefined list of optional solutions (multiple choices test).

According to some embodiments of the present invention, the same system may be used for evaluating and training a multiplicity of academic skill types and/or a multiplicity of languages.

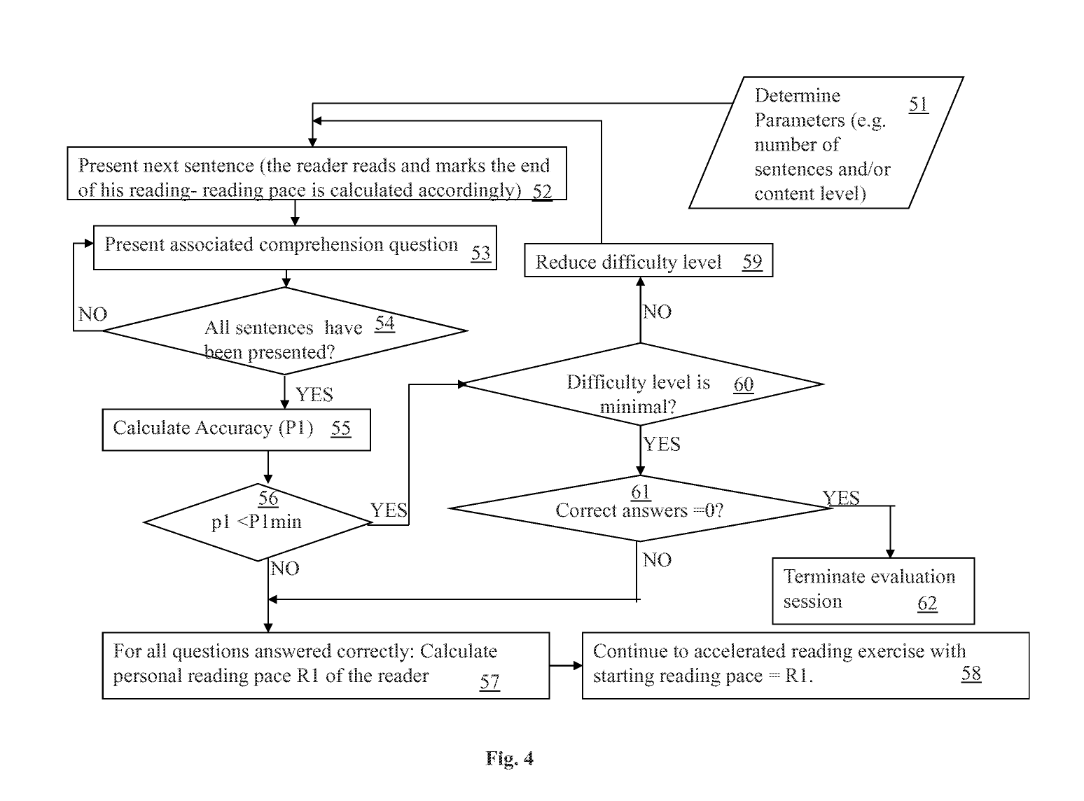

Reference is now made to FIG. 4, which is a flowchart, schematically illustrating a process of an initial assessment of a user's reading pace, according to some embodiments of the present invention. In this initial process, exercise parameters are determined 51, such as the level and number of sentences that will be included in the reading section in each exercise, etc. These parameters may be determined, for example, according to one or more of the personal parameters inputted by the user, such as the user's age, reading level, language level, personal preferences (e.g. area of interest), etc. In this example, a single sentence is presented at each iteration 52 where the user is required to indicate when he/she finishes reading the sentence by pressing a key for instance. Each sentence reading exercise is followed by an associated reading comprehension question 53. Once the user has finished the entire session including all predefined exercises 54 (including all sentences and questions), the evaluation module may calculate an accuracy level value P1, which may be the ratio between the number of correctly answered questions and the total number of questions 55. If this ratio P1 exceeds a predefined threshold P1min 56, the evaluation module estimates a personal reading pace R1 of the user 57 by calculating the reading paces Ri measured for all presented sentences that are associated with correctly answered questions for example by averaging them. Each such reading pace Ri may be calculated as the number of characters in the respective sentence Ci versus the measured reading time from the moment of presentation of the respective sentence until the pressing of the key Ti: Ri=Ci/Ti, measured for example as letters per millisecond. Once R1 is calculated it can be used as an initial reading pace in an advance accelerated reading exercise for calculating a more refined and accurate reading pace value R2 58.

According to some embodiments, as illustrated in FIG. 4, if the accuracy level P1 has not exceeded the predefined threshold P1min 56, evaluation module may check the difficulty level 60 and if the difficulty level has not reached a minimum value, the difficulty level may be reduced 59, e.g. by selecting simpler and/or shorter sentences. If difficulty level reaches a minimum threshold, e.g. the user has not given a single correct answer to the questions 61, the evaluation session is terminated.

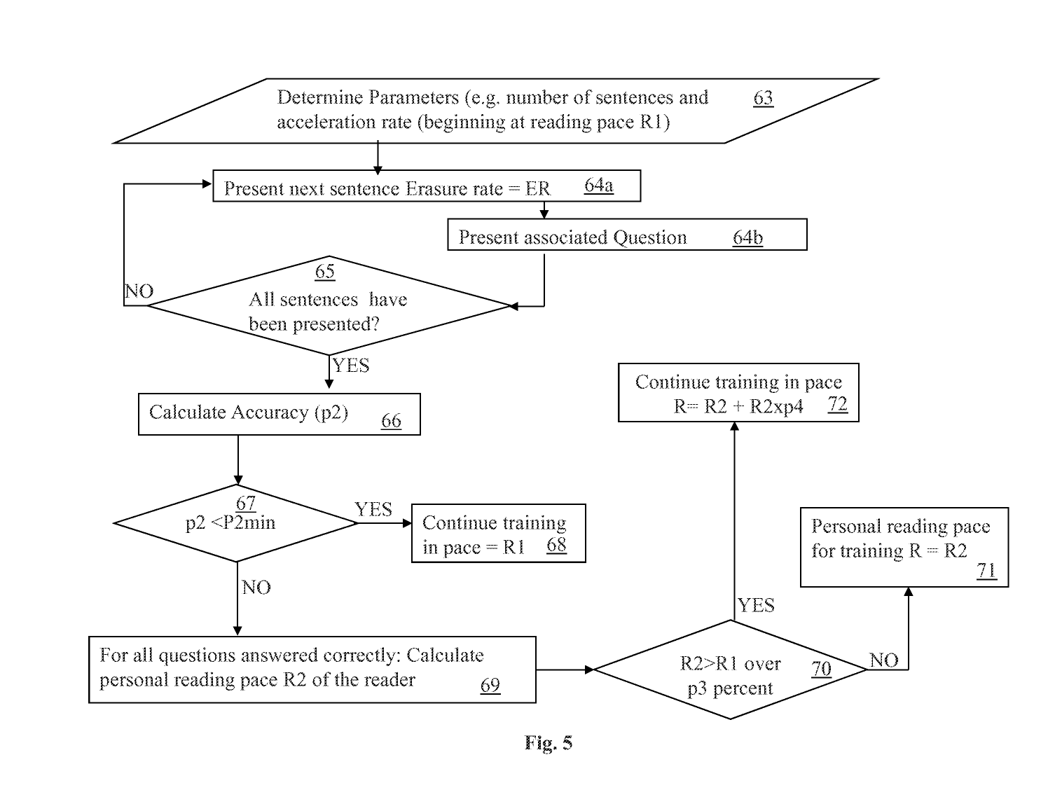

Reference is now made to FIG. 5, which is a flowchart, schematically illustrating a method of evaluating reading skills of the user using a refined assessment process based on resulting reading pace R1 of the initial assessment process, according to some embodiments of the present invention. In this refined process, both the sentences and an acceleration rate are determined 63. A single sentence is presented and graphically manipulated (e.g. text erased letter by letter, from start to end of text) in relation to the acceleration rate at each iteration 64a where the user may be required to indicate when he/she finishes reading the sentence even before the text has completely disappeared, by pressing a key for instance. Each sentence reading exercise is followed by an associated reading comprehension question 64b. Once the user has finished the entire session including all predefined exercises 65 (including all sentences and questions), the evaluation module may calculate another accuracy level value P2, which may be the ratio between the number of correctly answered questions and the total number of questions 66. If accuracy level P2 exceeds a predefined threshold P2min 67, A second reading pace R2 is calculated in a similar manner as R1 is calculated 69. If P2 does not exceed the threshold P2 min, the personal reading pace of the user taken into consideration for the training will be r1 68

If R1 has been calculated, evaluation may further check whether R2 is higher or lower than R1 70. If R2>R1 over a predefined rate, such as over 3% meaning if R2>1.03×R1, then this process may be repeated at a new starting reading pace R1=1.04×R2, and if R2<1.03×R1, then the process may be repeated where R₁=R2.

The refinement process may be repeated a predefined number of time until reaching an optimal reading pace. This optimal reading pace may then be taken as the personal reading pace of the user for adapting and tailoring the training program to the user.

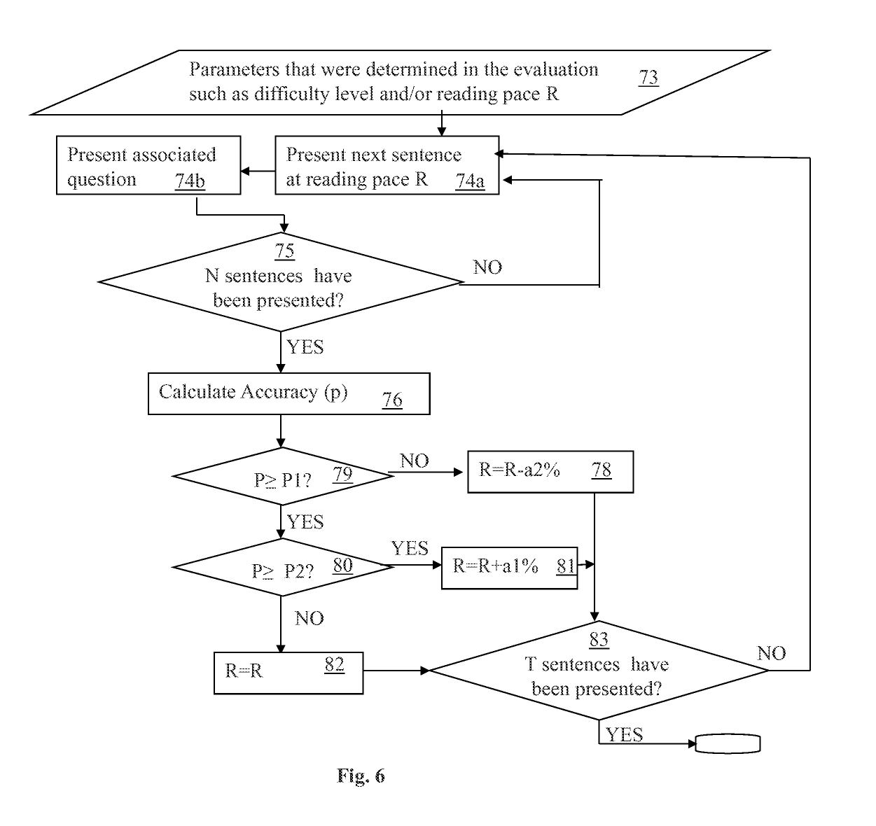

Reference is now made to FIG. 6, which is a flowchart, schematically illustrating a process of training a user using an acceleration-based reading training program, according to some embodiments of the present invention. The initial reading pace R and difficulty level may be received by the training module from the evaluation module 73 to initiate the training using these parameters. The training process includes presenting each sentence of the training program 74a according to a presentation pace (which depends on an acceleration rate determining the rate of speeding or slowing down of the presentation pace) R starting from a value equivalent or proportional to the personal reading pace. The reading pace is controlled and dictated by the training module by, for example, controlling rate of presentation of each letter in each sentence by erasing letters from start to end of each sentence from the moment of first presentation of the entire sentence until a predefined time interval at the end of which all letters of the sentence are erased. The erasure rate is initially determined according to initial reading pace R. After each sentence comprehension verification is attempted, e.g. an associated question is presented requiring the user to answer it by selecting one of multiple given answers 74b. Once all questions in the respective training session are answered and all sentences presented 75, the training module calculates an accuracy level P as indicated in box 76, which may be calculated as the ratio between the number of correctly answered questions and the total number of questions.

In the training process two different accuracy level thresholds may be defined: a first threshold, which may be equal to P1 and a second threshold, which may be equal to P2 where P2>P1 meaning that P2 represents a better accuracy than P1. If accuracy level P exceeds or reaches the first threshold P≧P1 as indicated in box 79 and yet does not reach the second threshold P<P2 as indicated in box 80, acceleration rate R remains the same as indicated in box 82. If accuracy level P does not reach the first minimum accuracy level P1, as indicated in box 79, the acceleration rate is reduced by a predefined “a2” rate (which may be calculated in real time, according to performances, or is a predefined constant), as indicated in box 78. If accuracy level P reaches or exceeds the upper second threshold P2, as indicated in boxes 79 and 80, the acceleration rate is increased by a predefined “a1” rate (which may be calculated in real time, according to performances, or is a predefined constant) as indicated in box 81, which may be equal to a2 or different therefrom.

The training module may repeat these steps indicated in boxes 74a-82 until all predefined sentences number T are presented and all associated questions are answered, as indicated in box 83.

According to some embodiments of the present invention, the training may additionally or alternatively include one or more games that allow reading verification and/or assessing of accuracy level (e.g. reading comprehension) and/or training additional reading or language skills such as categorization of text (words) and/or enriching users vocabulary. In these training sessions, designed as games, the user is presented with a category such as “verbs”, “nouns” and the like, or “animals”, “objects” and the like. Words for categorization are then presented to the user, each for a predefined time interval determined according to the dictated acceleration rate R. The user is required to decide whether the presented word is associated with the presented category or not, for example, by pressing one key for “yes” and another key for “no”. The time interval for presenting each word may be accelerated according to the user's performances starting with an initial interval “ti” for each word calculated according to the personal reading pace of the user outputted by the evaluation process and optionally according to the number of characters (letters) of each of the presented words. This means, that if personal reading pace R1 is of a number of characters per seconds, for instance, the training module is programmed to calculate the time interval for presenting each word as: the personal reading pace R1 divided by the number of letters in each respective word to be presented Ni: ti=R1/Ni. Accuracy level in these exercises may be calculated as the number of correct associations versus the total number of words presented in each respective exercise.

The time interval ti for presenting each word may be decreased if performances exceed a predefined threshold level. For instance, if accuracy level P exceeds a predefined threshold Po−ti may be decreased by predefined “a3” percentages: ti=(1−a3/100)·ti.

These categorization games may be used for evaluating and/or training language skills of users additionally or alternatively to being used as training sessions/exercises. These games can serve not only for evaluating, improving or teaching categorization of words but for evaluating and/or training reading skills such as decoding and comprehension as well.

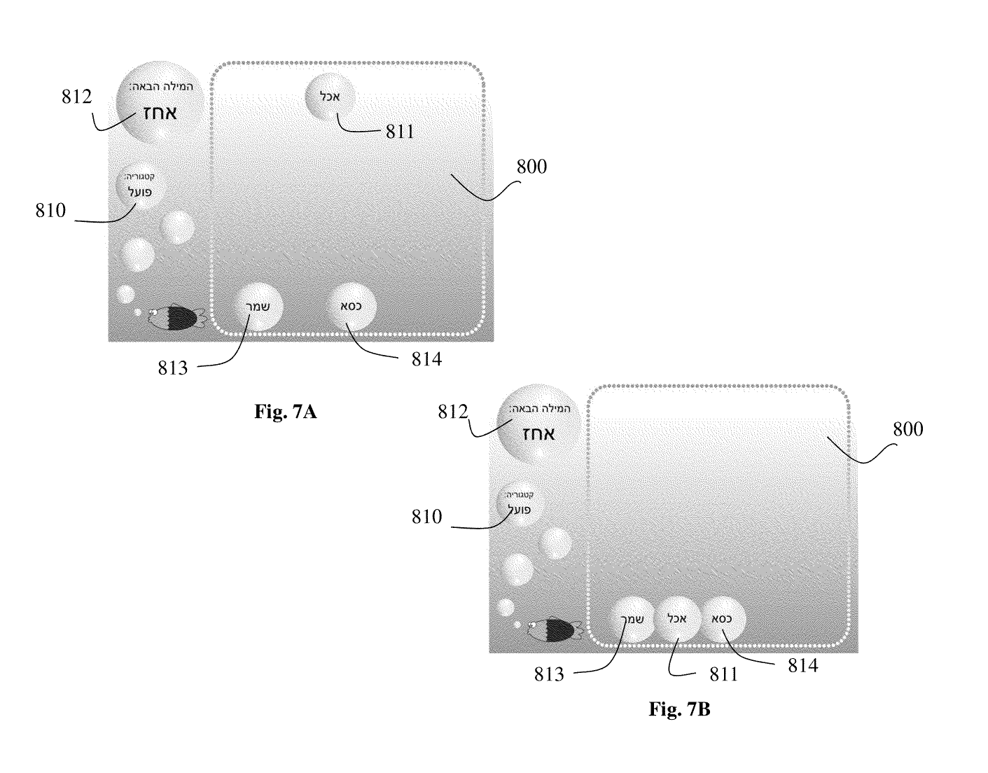

Different graphical effects may be used for presenting each such word and various presentation manipulations may be applied. In the following FIGS. 7A-7B, 8-10 and 11A-11C three examples to such categorization games and presentation manipulations are shown.

FIGS. 7A and 7B schematically illustrate a bubble game exercise that allows the user to associate words to linguistic categories such as verbs, nouns and the like, according to one embodiment of a training exercise. The category in this case is “verbs”, where each word appears inside a bubble that descends from an upper location of the window downwards. The purpose of the game is to construct “legal” chains of words representing a designated category. To do so, the user is required to drop the bubble to a lower raw for creating a bubbles-chain of a predefined length (e.g. 2) representing the same category (i.e. chaining together two word-bubbles representing the same designated category). If the user attaches the bubble to another bubble representing a different category, then this chain is considered as an “illegal” chain. The descending rate and/or other presentation parameters (e.g. text fadeout speed and/or text disappearing speed) relates to the dictated acceleration rate determined according to the user's performances and/or in relation to his/her personal reading pace.

According to some embodiments, several word bubbles may appear having a period of time in which they are presented simultaneously in some more advance stages of the game. The game may continue by filling legal bubble chains, consequently freeing (emptying) the place in the row occupied by the constructed legal chain, and providing space to continue the game (like in Tetris game). The game may be over when the user fails to create legal chains and a specified number of rows are filled (and overflow) or when a predefined N number of words have been presented. The training/evaluation module may enable random retrieval of words from a predefined words list. The system may include several words lists for each language each list associated with one or more different parameters such as age, language level of the user, user preferences (area of interest) and alike. Therefore, the words are selected according to one or more of the personal details of the user and optionally also according to the user's evaluated parameters such as reading pace and accuracy level. FIG. 7A shows a bubbles game window 800 where two words 813 and 814 are already selected as associated with a “nouns” category previously presented. The user is required to build bubbles pair-chains, where in each pair-chain, both words are associated with the same category indicated by category bubble 810, which may change over the exercise. In this example the category “verb” is presented. One other word bubble 811 is floating in window 800 and should be dragged and dropped by the user to for coupling it with another verb bubble. In this case word bubble 813 represents a verb and bubble 814 represents a noun. Another word bubble 812 may be presented at a designated location indicative that this is the next bubble to be released into window 800. In FIG. 7B the user has coupled bubble 811, which is a verb, with bubble 813, which is also a verb. Once a pair is created it may disappear and free row space for additional bubbles. Accuracy level may be calculated according to the number of correct couples versus the total number of presented words divided by two.

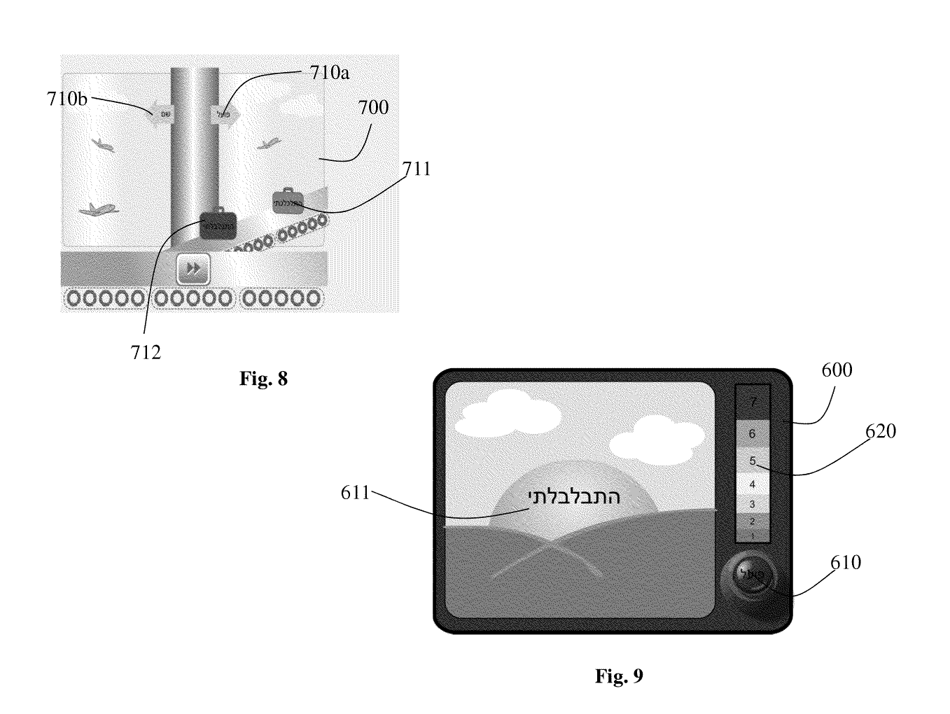

FIG. 8 illustrates a window 700 of an “airport” words game, in which pictures of different suitcases having words presented thereon are moving along an illustrated conveyer. Two categories 710a and 710b are presented as arrows each leading to a different direction. In this case the categories are “verbs” 710b and “nouns” 710a. The user is required to press the arrow category that is associated with the descending suitcase to associate the word thereof to the category he/she thinks is the correct one. The system enables controlling all the descending speed of each of the suitcases, the time the text appears inside the suitcase until disappearing or fading out as well as a time interval between the appearing of one suitcase and the next. All these speeds and rates may relate to the user's personal estimated reading rate and/or acceleration rates calculated throughout the training program, either this game or any other training and/or evaluation exercise or program. In this example, two verb suitcases 711 and 712 move along the conveyer allowing the user to select the category each belongs to by pressing the “verb” arrow 710b. Once selecting the verb category the suitcase is positioned at a respective side of the window 700 (e.g. at the bottom right side thereof).

FIG. 9 illustrates a window 600 of a TV words game, according to which, words are revealed one after the other over an illustrated TV, where the category 610 is presented as an operation button. If the word is associated with the category, the user is required to press a designated key/button (e.g. the category key 610) as fast as possible and if not, the user is required to ignore the word. In this example, a success meter 620 is also presented to the user indicative of the ratio between the number of correct association in relation to the number of current total iterations/words presented or the number of correct associations. Once the user reaches a predefined upper success rate (e.g. when the user accumulates seven successful associations) a short message or a short animation may be presented as an award. The rate of word presentation and presentation time of each word may be controlled by the system and may relate to the user's personal estimated reading rate and/or acceleration rates calculated throughout the training program, either this game or other module.

FIG. 10 shows another “flying balloon” game. In this game a flying balloon 500 is presented, indicative of a category (e.g. “verb”) 510. The words 511 are presented over the balloon, where the user is required to press an “x” key if the word belongs to the indicated category and ignore or press the “Y” key if not. If the association is correct, the balloon 500 is flamed and rises up in the air. After a predefined number of successful associations, a short animation showing the balloon 500 flying in the air is presented and another balloon may be presented starting a new exercise for encouraging the user to accumulate successes to fly that next balloon. The rate of word presentation in the balloon and presentation time of each word may be controlled by the system and may relate to the user's personal estimated personal reading pace and/or acceleration rate calculated throughout the training program, either this game or other module.

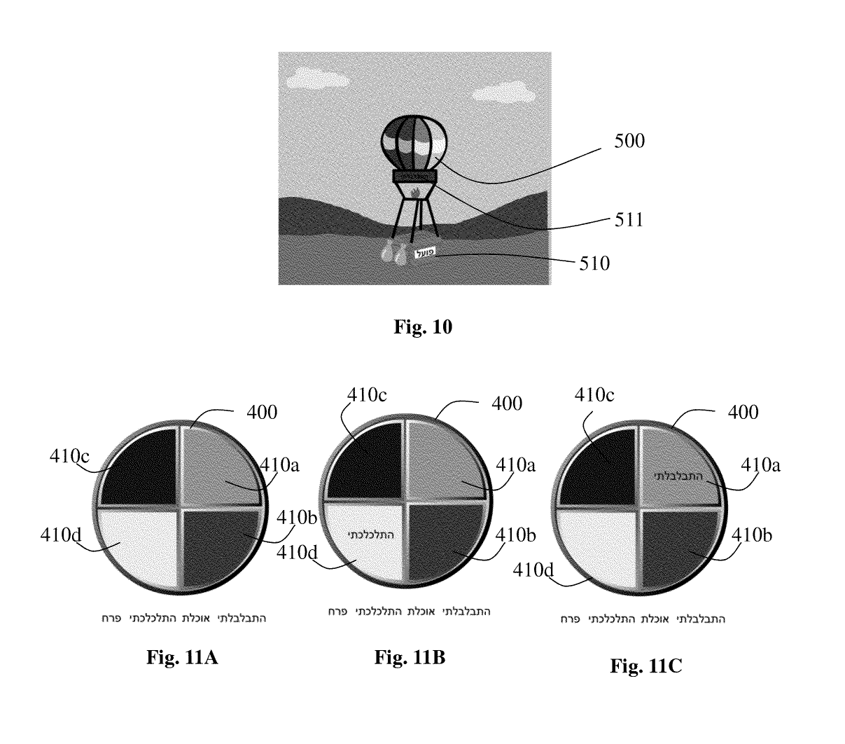

FIGS. 11A, 11B and 11C schematically illustrate a memory game, in which a raw of words is presented. A circle 400 divided into four quarters 410a, 410b, 410c and 410d each having a different color is presented. At each given time interval, one of the words in the raw appears over one of the quarters, requiring the user to memorize the order of words as appearing in circle 400 and repeat it by pressing the words in the raw.

According to some embodiments there is provided a method for improving reading speed and comprehension of users, using a designated software application operable through at least one computer processor. The method includes: (i) receiving reading level of a user either through inputting through an interface of the software application or by retrieval thereof from data storage as well as receiving personal details of the user which may also be inputted through the interface; (ii) setting initial presentation pace and acceleration rate of the user; (iii) presenting textual content (also referred to simply as “text”) over a computer screen or any other computerized/electronic display device, where the text is selected according to the received reading level and personal details and optionally according to other input details such as the Language level (first second etc.); (iv) determining a current presentation pace according to the initial presentation pace and acceleration rate at each given timeframe; and (v) manipulating presentation of text parts of the presented textual content at each given timeframe, according to the current presentation pace.

The manipulation can be done by erasing, blurring or graphically manipulating text parts in any other manner that makes this text part hard to visually identify. The manipulation is done at a rate/pace that corresponds to the current presentation pace of the specific timeframe (if accelerated than higher than the initial presentation pace after the text is presented for some time). The text parts manipulation may be done character by character (letter by letter) or word by word from beginning to end of the textual content presented such that once the user read some of the text he/she can no longer revert to it to better understand the meaning of the entire or part of the content that is being presented until the entire test (paragraph or more) is erased/blurred.

This method assures that the time allocated for reading each text part or paragraph etc. is not exceeded by the user and forces the user to read faster by gradually accelerating the rate in which these text parts are erased/blurred etc. This method further forces the user to concentrate to comprehend the text he/she is reading in a much more efficient and faster manner training the user thereby to improve his reading skills i.e. reading speed and comprehension combined. According to some embodiments, the software program also carries out an evaluation process in which the reading level of the user is evaluated e.g. through reading speed and comprehension exams, where the initial reading level and acceleration rate are calculated and inputted automatically by the software before the text is presented. The evaluation optionally includes presenting reading comprehension exercise(s) and evaluating the reading level according to a scoring of the user in the exercise. The evaluated reading level may be presented to the user over the computer screen.

According to some embodiments of the invention, the system may include an eye tracking device for automatically tracking the user's eye(s) while the user is reading the presented textual content. The eye tracking device may be configured for measuring eye movements e.g. by measuring the positioning of the pupil and transmitting data indicative thereof to the processor of the computer, which operates the software program. The processor analyzes the data from the eye tracking device for evaluating reading speed of the user and may calculate the user's reading level thereby. The current presentation pace is determined at each given timeframe according to the previously measured reading speed.

The initial presentation pace can be either set by the user by inputting thereof through the user interface options or determined by the software according to the received personal details and reading level (e.g. from an evaluation done through the software).

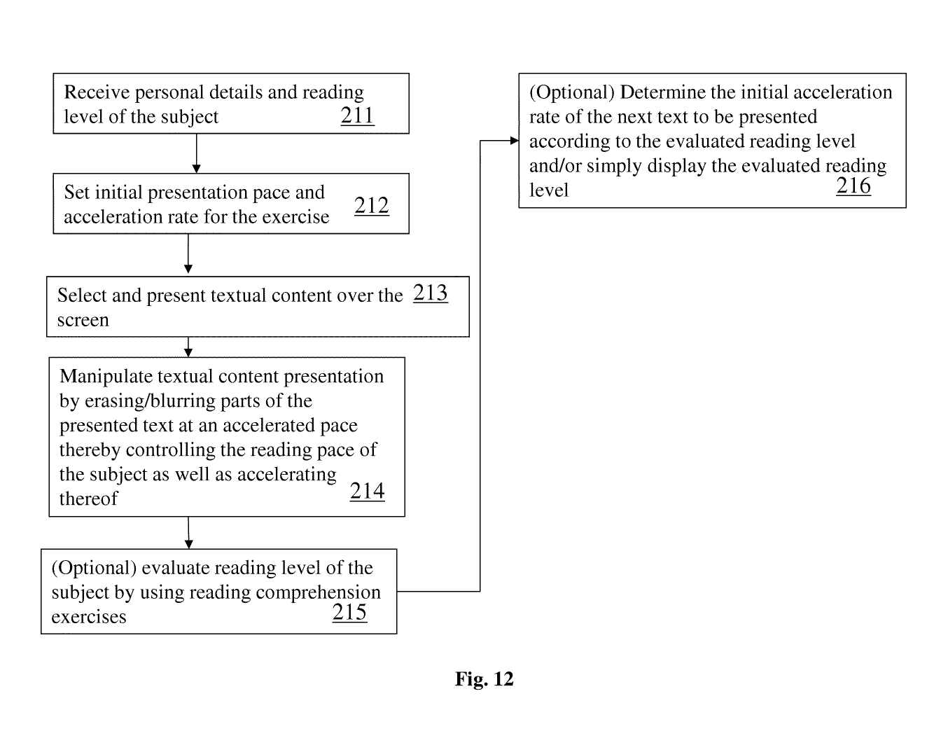

Reference is now made to FIG. 12 which is a flowchart schematically illustrating a process for improving reading speed and comprehension, according to some embodiments of the invention. The process or method includes: (a) receiving personal details such as age, gender and reading level 211 either as a direct input from the user or from a computer storage; (b) setting an initial presentation pace and acceleration rate 212, wherein the processor either evaluates a suitable initial presentation pace and acceleration rate according to the reading level and other personal details such as age of the user or receives an input from the user who can fit these parameters values according to his/her desire (through a user interface of the software); (c) selecting and presenting textual content 213 (e.g. one or more paragraphs), where the content, length and difficulty level of the presented text are selected according to the input data; and (d) manipulating the presented textual content according to the presentation pace while accelerating this pace according to the acceleration rate 214, wherein the manipulation includes erasing or blurring of text parts from beginning to end thereof or graphically manipulating these text parts in any other way in which they become difficult or impossible to read.

Optionally, as illustrated in FIG. 12, a reading level of the user is evaluated through an evaluation exam or process 215 after each text is erased or blurred completely. This may be done for example, by measuring the time interval between the moment the entire text was presented until it was erased/blurred completely or by receiving input from the user that he/she has finished the text (if this happens before the entire text was erased/blurred) as well as by providing a short reading comprehension text or by using automated devices such as eye tracking device that allow real time measuring of the focus of the eye and therefore the reading speed. Once the reading level is evaluated it may be used to determine the acceleration rate of text erasing/blurring for the next exercise or the next time the user uses the program 216.

The process may also include receiving other input data such as language selection and language level (e.g. a first language (native language) or a second (foreign language) and the like) according to which the textual content to be presented is selected and the initial presentation pace and acceleration rate are calculated/estimated.

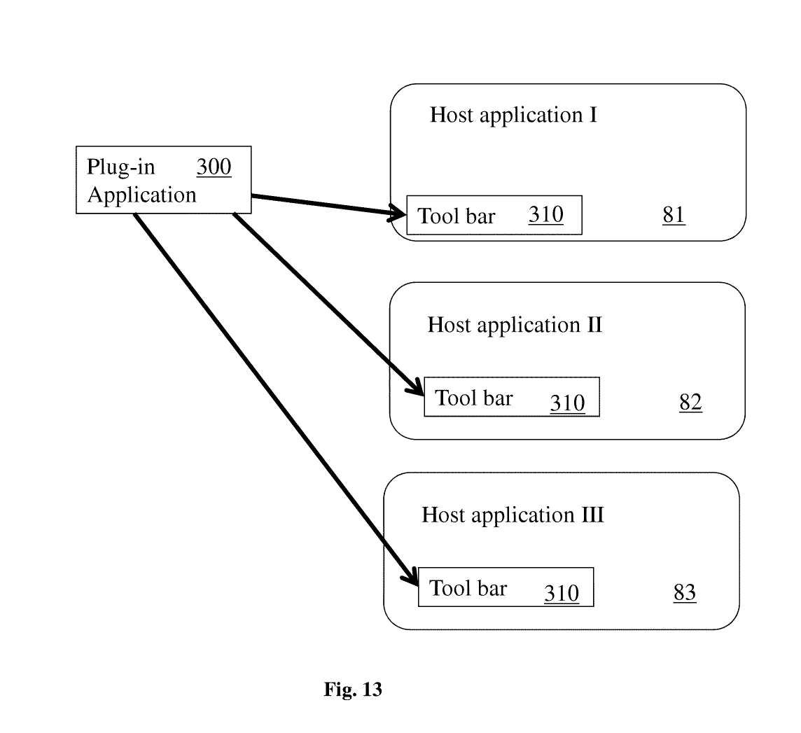

Reference is now made to FIG. 13, which shows how the program can be implemented as a plug-in software application 300 that can use other programs 81-83 that present text such as internet platforms for showing webpages, WORD™ and other text editing and writing programs, electronic books programs and the like, according to some embodiments of the invention. The plug-in application 300 is configured to add-on a toolbar interface 310 to the specific text program either automatically or upon a user selection allowing the user to operate the presentation manipulation according to various input data he/she can enter or download through the toolbar interface. For example, once the plug-in application is installed at the user's computer it automatically adds an operation button to the standard toolbar of the text program allowing the user thereby to open the full toolbar of the plug-in application 300. This toolbar interface allows the user or another user on his/her behalf (in case of a child user for instance) to input his/her age, select a language and define his/her level in the language and the like and optionally also select the acceleration rate and initial presentation pace, where an estimated acceleration rate and presentation pace (estimated according to the age and language level of the user) may be suggested in the selection options. Once these parameters are entered and selected, the application 300 operates the text manipulation (i.e. erasing/blurring effect) for the text sections displayed thereby. For example, for a webpage having articles displayed thereby the application 300 may be configured to allow the user to select the article by entering thereto through the website and once the article is displayed in its full version (such as in news websites) the letters and words thereof begin to disappear one by one according to the presentation pace where this pace is accelerated over time either from one timeframe to another or from one paragraph to another, depending on the application 300 definitions.

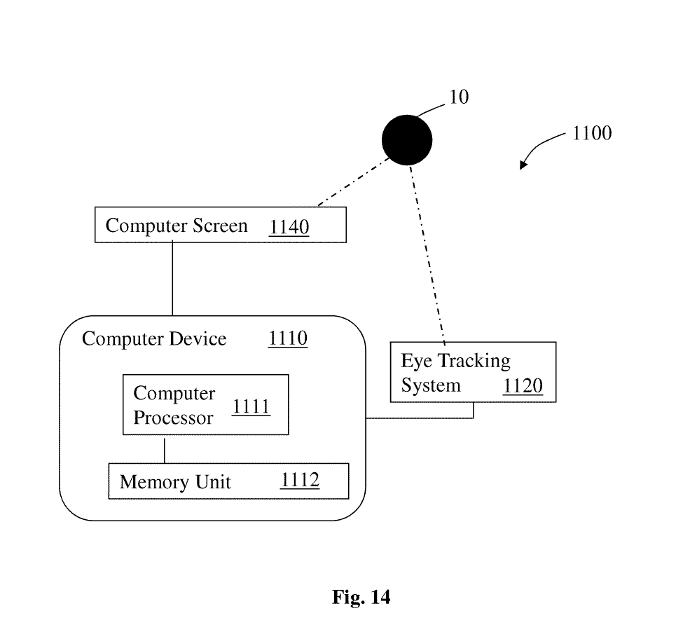

Reference is now made to FIG. 14 showing a block diagram, schematically illustrating a system 1100 for improving reading speed and comprehension of a user 10 that includes an eye tracking device 1120 for automatically measuring eye movements of the user 10 for deducing the user's reading speed therefrom, according to some embodiments of the invention. The system 1100 also requires using a computer device 1110 with a processor 1111 and memory 1112 having a designated software program/application (whether a plug-in or a non-plug in one) for receiving data from the eye tracking device 1120 and analyzing thereof to estimate the reading speed of the user 10 in real time and setting the presentation pace and accelerating thereof according to the real time reading speed results. The eye tracking device 1120 used may measure the gaze and/or the eye movements and output data indicative of the measured parameter(s). This data is then analyzed at the computer processor 1111 for identifying the location of the gaze in terms of text letters/words. This information accumulated over a timeframe is then used to deduce the reading speed of the user (e.g. words or letters per time unit).

The eye tracking device 1120 may include a video camera that can be connected to the computer 1110 having a designated camera application and eye tracking software operable therethrough. The eye tracking software is configured to extract the camera output data of images and carry out image processing to identify the eye and the pupil or simply estimate the center of the eye upon identification of its contours, for instance. This information is then further processed to identify the relation between the positioning of the text letter displayed over the screen and the positioning of the pupil/center of the eye to estimate at each given short first timeframe (seconds or a fraction of a second) on which letter the user 10 focuses on. This in turn allows estimation of the number of letter read within a specific timeframe to allow estimation of the reading speed at each given second timeframe (e.g. each 30 seconds or each minute). The camera used may be a simple camera that may be already installed in the computer device (e.g. in case this computer is a mobile phone such as a smartphone having a video camera integrated thereto or a separate high resolution camera.

Any other device or system can be used instead or additionally to the eye tracking device to allow automatically identifying the text part (letter/word) the user focuses on at each given moment to determine his/her reading pace therefrom.

According to some embodiments, the user interface may also include an “advance” option allowing the user or user on his/her behalf to set additional functions. For example, the user may be able to set a scoring table in which the measured reading speed and optionally reading comprehension is indicated in a table with association to the reading level associated with the selected text and the date in which this text war read to allow the user to follow his/her improvement. Another function in the advance options may be the language selection and language level thereof (first, foreign and the like).

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Although the invention has been described in detail, nevertheless changes and modifications, which do not depart from the teachings of the present invention, will be evident to those skilled in the art. Such changes and modifications are deemed to come within the purview of the present invention and the appended claims.

1. A system for evaluating and training academic skills of users, said system comprising:
i) a user interface; and
ii) at least one processing unit comprising:
a) an evaluation module, which allows evaluating personal academic skills of each user by providing each user with an interactive evaluation program associated with said respective academic skill, using said user interface; and
b) a training module, which uses evaluation of a specific academic skill of each respective user, provided by said evaluation module, for training the user by adapting a personal training program to the respective user according to the user's respective personal evaluation, said training module further allows operating and presenting said personal training program using said user interface,
wherein said training comprises presenting content associated with said academic skill to the user and manipulating presentation characteristics of said content by manipulating a pace in which said content is presented starting from a pace that is associated with the evaluated personal academic skill of the user.

2. The system according to claim 1, wherein said academic skills include at least one of: reading skills, problems solving skills, arithmetic skills.

3. The system according to claim 1, wherein said evaluation includes presenting the user with text and determining a personal reading pace of the user and said training includes presenting text parts to the user and manipulating presentation pace of said text parts, according to said evaluated personal reading pace, thereby dictating reading pace of the user.

4. The system according to claim 3 further enables monitoring performances of said user during training and adjusting the training according to said monitored performances substantially in real time during said training by manipulating presentation pace of said text according to said monitored performances of the respective user.

5. The system according to claim 4 further enables providing reports, each indicative of training performances of a respective user, according to said monitored performances of the respective user.

6. The system according to claim 3, wherein said presentation pace manipulation includes erasing parts of said text according to reading order and according to a determined presentation pace.

7. The system according to claim 3, wherein said personal training program includes a number of training sessions each designed to be practiced at a different time period, each said training session includes at least one reading exercise and at least one accuracy level exercise, wherein said training comprises determining an acceleration rate, indicative of an increase rate of the presentation pace of said text parts, said acceleration rate is determined according to performances monitored during said training, using said accuracy level exercises, wherein presentation pace is increased by said determined acceleration rate during each respective training session.

8. The system according to claim 6, wherein each reading exercise is followed by a reading comprehension exercise including at least one multiple choices question for enabling to measure said accuracy level according to the number of correct answers to said questions.

9. The system according to claim 1, wherein said evaluation module allows a pre-training evaluation and a post-training evaluation, wherein results of each of said pre-training and post-training evaluations are presented to the user.

10. The system according to claim 1 further comprising at least one monitoring database enabling to store training and evaluation related information of each training and/or evaluation of each user.

11. The system according to claim 1 wherein said evaluation and training modules are operated through a web server for allowing to use said system through at least one communication network.

12. The system according to claim 1 further comprising at least one evaluation programs database including a multiplicity of evaluation programs and at least one training database including a multiplicity of training programs, said databases further allow retrieval of evaluation and training programs according to input parameters and storage of programs and programs related data.

13. The system according to claim 1, wherein said user interface allows the user to select a language out of a predefined list of languages, wherein said evaluation and training is carried out according to each respective selected language.

14. The system according to claim 1 further enables building, operating and presenting a personal training timetable indicative of schedules of sessions of said personal training program and alarm options, which allow outputting alarms indicative of each session according to said timetable.

15. The system according to claim 13 automatically presents said personal timetable upon adapting said personal training program, said UI enables the user to change schedule features thereof.

16. The system according to claim 3, wherein said training program includes at least one words game allowing a user to associate words with at least one category, said training module enables calculating and assigning a time interval for presenting each word said time interval is associated with the evaluated personal reading pace of said respective user and performances in previous training sessions.

17. The system according to claim 1 further comprising an administrator module enabling at least one administrator to receive text parts from at least one text source and construct at least one training and/or evaluation exercise out of each such received text part, wherein said user interface allows said administrator to carry out said construction of each said training and/or evaluation exercise.

18. The system according to claim 1, wherein said content presentation includes at least one of: visual content presentation, audio content presentation, tactile content presentation.

19. The system according to claim 1, wherein said training module further enables providing warm up exercises each said warm up exercise enables training at least one low-order cognitive skill, each said low-order cognitive skills is associated with the academic skill that is evaluated and trained.

20. A computer implemented method of training and evaluating academic skills of users, said method comprising:
a) evaluating at least one characteristic of at least one academic skill of a user by providing an evaluation program including an interactive evaluation platform associated with a respective academic skill; and
b) training the user in the respective academic skill according to said evaluated personal academic skill characteristic, said training comprises presenting content to the user and manipulating presentation characteristics of said content by increasing a pace in which said content is presented starting from a pace that is associated with the evaluated personal academic skill characteristics of the user.

21. The method according to claim 20, wherein said academic skills comprise reading skills of a specific language and wherein said training includes manipulating presentation of text according to the evaluated personal reading skill of said user in said respective language.

22. The method according to claim 20, wherein said evaluation includes evaluation of reading pace and accuracy level of a user in relation to a presented text, said accuracy level is evaluated by presenting the user with a set of questions relating to a content of the text and calculating said respective accuracy level according to the number of correct answers in relation to the total number of questions.

23. The method according to claim 20, wherein said evaluation comprises:
a) receiving personal details of the user;
b) retrieving an interactive evaluation program including at least one evaluation session, according to said personal details; and
c) presenting the user with content requiring the user to respond thereto;
d) evaluating at least one characteristic of the academic skills of the user according to the user responses to the presented content

24. The method according to claim 23, wherein said at least one characteristic of the user's academic skill is further evaluated in respect to the personal details of the respective user.

25. The method according to claim 23, wherein said at least one characteristic of the user's academic skill is further evaluated according to statistical information relating to said personal details and to the specific academic skill.

26. The method according to claim 20 further comprising monitoring a progress of each user during said training by storing performances characteristics in at least one predefined monitoring database.

27. The method according to claim 26 further comprising adjusting the training according to monitored performances of the respective user, during said respective training.

28. The method according to claim 26, wherein said monitoring further comprises ranking each performance of the user during the training, according to a predefined ranking mechanism and rewarding the user in respect to his ranking score.

29. The method according to claim 20 further comprising boost training including providing the user with booster training sessions to be trained by the user at a post training stage.
